(19) United States
(12) Patent Application Publication
(10) Pub. No.: US 2009/0178723 A1
(43) Pub. Date: Jul. 16, 2009

(54) SUPPORTIVE APPARATUS FOR PIPING AND SIMILAR STRUCTURES AND METHOD FOR THE USE THEREOF

(76) Inventor: JOSEPH CIOFFI, Middletown, NY (US)

Correspondence Address: LACKENBACH SIEGEL, LLP, LACKENBACH SIEGEL BUILDING, 1 CHASE ROAD, SCARSDALE, NY, 10583, US

(21) Appl. No.: 12/351,470

(22) Filed: Jan. 9, 2009

Related U.S. Application Data
(60) Provisional application No. 61/020,468, filed on Jan. 11, 2008.
(60) Provisional application No. 61/021,924, filed on Jan. 18, 2008.

(51) Int. Cl. F16L 3/00

(52) U.S. Cl. 138/107; 138/149

(57) ABSTRACT

A pipe support construction is provided that simplifies commercial installations of plumbing and steam fitting pipes and pipe assemblies. The present invention allows for comprehensive, one hundred percent, insulation coverage on any pipe without use of any accessories. The pipe to be installed is supported directly within the pipe support apparatus through use of a circumferential clip formed into a support and tightened with a screw. Intense friction is applied that prevents shifting of pipe along its length, thereby ensuring proper placement is maintained and there is no injury to the pipe. The base of the support is stamped of flat steel with a bolt hole, or opening provided thereby, allowing support to be mounted in any orientation, and with a multitude of hardware options.

### CROSS REFERENCE TO RELATED APPLICATIONS

This application claims priority from U.S. Provisional Application Ser. No. 61/020,468 filed Jan. 11, 2008, and fully incorporates the entire contents thereof by reference. Additionally, this application is related to U.S. Provisional Application Ser. No. 61/021,924 filed Jan. 18, 2008, and fully incorporates the entire contents thereof by reference.

### BACKGROUND OF THE INVENTION

1. Field of the Invention

The present invention relates to an apparatus for supporting pipes and other structural components. More specifically, the present invention relates to a supportive apparatus and method for the use thereof enabling continuous insulation coverage for a supported pipe and preventing unintended displacement of the pipe.

2. Description of the Related Art

The related art involves commercial and industrial applications, wherein physical supports are provided to various pipes, conduits, tubes, and the like (collectively hereafter pipes and/or conduits), designed to convey hot or cold materials such as: steam; chemicals; hot oil; coolant; refrigerant; chilled water; warm and cooled air; and, many other products that differ in temperature from their surroundings. It is common practice for these materials to often be under pressure (for example high pressure steam), thereby enhancing their physical danger.

It is also common practice to insulate such pipes, not only to maintain the conveyed material as near as possible to desired temperature, but also, in the case of cold materials, to prevent condensation (sweating) which occurs because of contact between the ambient moisture on a cool pipe surface and the temperature of the transported materials, frequently with attendant rusting of parts and degradation of the pipe integrity.

Furthermore, modern construction codes frequently require that pipes carrying materials of temperatures differing significantly from the ambient temperature must be insulated. Thus, despite these challenges, the industry standard today attempts to maintain the integrity of the insulated pipe. As of yet, the efforts exerted to meet this challenge have been unable to keep up with the expectations.

To achieve a maximum insulating effect, it has been the usual practice to insulate the entire length of pipe and place a hanger on the outside in compressive or supportive contact with the insulation. Consequently, the insulation itself acts as a structural member in supporting the pipe to the detriment of the operational integrity of the insulation. As will be discussed below, the portions of such conventional hangers contacting the insulation normally are of relatively narrow width, necessarily resulting in large stress concentrations over a small area of the insulation. It is also known as desirable to minimize supports on a pipe due to the detrimental insulative impact; and, unfortunately, this spacing of supports further enhances the negative impacts of supporting via the insulation itself.

Since thermal pipe insulation is by nature porous and fragile, the stress concentrations of pressure over a relatively small area frequently crush and deform the insulation. In time, often aided by vibration or jarring of the pipe, the crushed area may flex, and certainly continue to deteriorate over time, forming not only an unsightly appearance but, more seriously, reduction in the desired insulating effect.

Consequently, it is necessary that the insulating material utilized have significant load bearing capacity so as to prevent crushing of the insulating material and diminution of its insulating ability. These insulating abilities require use of a material possessing much greater density and load carrying ability than material which may be utilized at intermediate points wherein no load carrying capacity is required. Such higher density load carrying materials are necessarily more costly to manufacture and machine that the lower density insulation utilized on the remainder of the pipe.

Conventionally, in long horizontal pipe runs, it has been necessary to support pipe by means of spaced clevis pipe hangers. In the event that the pipe required thermal or acoustical insulation, blocks were utilized to temporarily support the bared pipe in the pipe hangers so that a suitable pipe-spacing could be maintained during initial pipe installation. Such blocks would then be removed as special insulation was inserted around the pipe adjacent the pipe hanger. At each hanger is an insulation assembly, typically cylindrical, around which the hanger extends. Common materials used for making components of these insulation assemblies are: calcium silicate; foam polymer; or, cellular or fibrous glass. Materials such as glass fiber or calcium silicate have the disadvantages of being brittle, having insufficient supporting strength and lack of compressibility.

During installation of these systems, commercial journeymen pipe fitters typically install the lower, generally semi-cylindrical, block beneath the pipe when installing the hanger. The upper part is left to journeymen insulators who subsequently install insulation jackets over the length of the pipe between the hangers. Insulation installers dislike the task of inserting the upper block and completing assembly of the hanger arrangement since it is difficult to get the various components properly assembled with each other, all while the weight of the pipe is suspended without flexing. It should be recognized here that such pipes may be extremely weighty, for example an 8-inch cast iron steam pressure pipe may weight up to 30 lbs/foot, such that a 50 ft run would have a total weight, empty, of 1,500 lbs before being filled. Consequently, less than a desirable job is very often performed.

Another fairly common occurrence is the tendency for the supporting hanger to slip off the end of the installed lower insulation block causing the supportive pipe, and any nearby pipe-joints to experience a flex-force, weakening the joint and potentially damaging the integrity of the pipe itself. All of these factors detract from the proper installation and or suspension of the pipe.

Another especially common method of installation is for pipe fitters to install a similarly designed half cylinder of sheet metal (called a “shield”) over what is commonly called a “strut channel” or “strut”. Within such a shield, the pipe fitter will typically install insulation and pipe, and wrap the entire installation with an oversized “strut clamp”, as detailed in U.S. Pat. No. 2,345,650 (see FIG. 6), the entire contents of which are herein incorporated by reference, which is intended to provide a firm grip on all components of the installation: pipe; insulation; and, sheet metal shield. Those skilled in the art of such installations will appreciate that this installation is especially cumbersome and requires flawless coordination between a pipe fitter and insulator, often spaced apart by days, to be successful. This is rarely the case; and, more often than not, the installer simply discards the fragile hardware in favor of completing his task with haste.

Within all the aforementioned installation techniques, the installer is required to either coordinate heavily with the piping contractor, or employ time consuming techniques of cutting, hollowing, and otherwise altering pre-formed insulation material, and applying loose insulation with polyvinyl covering and pliable vapor-proofing mastic in order to insulate relevant piping. The reasons such elaborate installation rituals have been established are manifold, but are based largely on energy conservation and climate control.

A number of alternatives have been patented, as discussed below, each of which hopes to address the unique issues of providing 100% insulation coverage on piping. In contrast to these conventional disclosures, the instant invention simultaneously provides for a quick and simple installation which utilizes a minimum of components. Many previous designs are cumbersome to employ and rely on a multitude of hardware components to operate properly.

As noted, in U.S. Pat. No. 2,304,973 to Vecchiola, the entire contents of which are incorporated herein by reference, there is disclosed a simple sheet metal strap designed to wrap a pipe with a thin protection through a coverage of insulation which does not interfere with placement of insulation. This design is inexpensive to employ, yet has several distinct disadvantages. Because it is a flexible hanger, pipe can only be supported in a horizontal position; the fact that the strap must be flexible enough for human hands to shape limits the gauge thickness and strength of the hanger; and, altering the shape of any metal changes the structural characteristics in an unpredictable manner.

U.S. Pat. Nos. 3,065,768 and 4,804,158 provide for exceptional insulating properties in conjunction with free movement for expansion and contraction of the pipe, yet are so exceedingly complicated in the number of parts and design, that they would only be used on the largest and most critical of services.

A number of related references employ the aforementioned and flawed concept of shielding insulation in such a way as to spread the weight of a pipe and its contents over a large area of insulation so as to minimize crushing or distorting the insulation. As will be recognized by those of skill in the art, instead of finding a way to support pipe independently and apply insulation over the support, these patents provide for supported insulation, which in turn supports the pipe. Therefore, as must be recognized, these designs are necessarily flawed. These references include U.S. patent Numbers: U.S. Pat. No. 3,122,346; U.S. Pat. No. 3,244,388; U.S. Pat. No. 3,530,899; U.S. Pat. No. 3,539,137; U.S. Pat. No. 3,653,618; U.S. Pat. No. 3,628,760; U.S. Pat. No. 4,146,203; U.S. Pat. No. 4,323,088; U.S. Pat. No. 4,530,478; U.S. Pat. No. 4,772,507; U.S. Pat. No. 4,765,577; U.S. Pat. No. 5,192,039; U.S. Pat. No. 6,126,119; U.S. Pat. No. 6,224,025; and, U.S. Pat. No. 6,691,742, the entire contents of each of which are herein incorporated by reference.

Two particular designs appear in U.S. Pat. No. 4,804,158 and U.S. Pat. No. 4,852,831, the contents of each of which are also incorporated herein by reference. Each provides a construction involving pipe support; but, each contains a number of particular drawbacks and detriments appreciated by those of skill in the art. The former design utilizes a highly complex (25 or more pieces) assembly to be successful in its application; and, by the admission of the inventor, is intended for large nuclear service pipes. The latter is made of readily damageable and broken material and can only be used in a horizontal setting.

In view of the above discussion, reference is now made to FIGS. 1 through 2A, wherein two alternative conventional constructions are discussed. In FIGS. 1 and 1A, a conventional dual-C type support element 1 containing opposing support shell members 2, 2 positioned to grip a pipe member 3 and suspend the same from a support assembly 4 relative to a conventional channelized support bar 5. A conventional insulation member 6 is positioned about pipe member 3 and contains a central slit 7 or slit channel 7 and is wrapped with a bounding flexible member 8.

As will be appreciated by considering FIGS. 1 and 1A, shell members 2, 2, are positioned on opposing sides of pipe 3 and opposing bolt members 9, 9 are secured, joining shell members 2, 2 and clamping pipe 3 therewithin. Next, an additional bolt member 9 secures the assembly with channel member 5; and, insulation member 6 is positioned on opposing sides of the joined shell members 2, resulting in an insulation gap 10 between opposing faces of insulation members 6. This insulation gap 10 necessarily results in thermal loss and condensation/oxidation of the fitting during use.

Referring specifically now to FIGS. 2 and 2A, an alternative conventional structure is discussed and is noted in the publications noted herein. Channel support member 5 supports a conventional bolt attachment member 4 as discussed above. Different from the construction in FIGS. 1 and 1A, however, is the use of a saddle support member 11, comprising a first saddle support or U-support member 12 and a second tension member 13 having spaced apart ends maintained in such separation by a tensioning truss bolt member 14 which is employed to resist the compressive forces exerted thereon by the weight of the pipe assembly. Similar insulation members 6 are positioned thereon and again provide an insulation gap 10 between opposing insulation faces.

As will be appreciated by those of skill in the art, each of the above noted conventional embodiments prohibits simple adjustment as to pipe position or non-uniform support brackets—common in the inexact assembly of a building or in the construction trades—so as to allow easy maintenance of pipe position. These conventional systems require the use of differently shaped components selected to match the inexact position of a support stud or channel; and, as a result, require assembly teams to carry an array of different shapes to adapt to construction differences along the pipe-installation route.

None of these prior art devices utilized for supporting and insulating pipes solves the concerns in the related art. That is, none can satisfy insulation requirements while maintaining easy and economical manufacture, easy on-site assembly, reduction in labor hours and related cost while providing a superior assembly with considerable increased safety to the workers. These earlier devices also fail to be readily adaptable to differing construction techniques or non-uniformity of available construction supports.

Accordingly, there is a need for an improved assembly and method for using the same that responds to the details as discussed herein.

### ASPECTS AND SUMMARY OF THE INVENTION

An aspect of the present invention is to provide an apparatus for supporting pipes and other structural components.

Another aspect of the present invention relates to a supportive apparatus and method for the use thereof enabling continuous insulation coverage for a supported pipe and preventing unintended displacement of the pipe.

It is therefore an aspect of the present invention to provide a support device for insulated pipes which is capable of providing strong, lateral support in combination with effective insulation, adapted for easy assembly on the job site, simple in structure, and economical to manufacture.

It is another aspect to provide the above assembly employing a robust but adjustable bow or cam shaped stanchion having a cylindrical clip mounted on the uppermost portion thereof to firmly grip pipe, and with a stamped base which will easily mount to regular construction materials with a minimum of readily available hardware.

It is another aspect of this invention to provide for complete (100%) coverage of insulation over the surface area of a pipe.

It is another aspect of this invention to eliminate the need for insulation material over and above commonly available fiberglass insulation during an initial installation step of a pipe.

It is an aspect of the present invention to minimize the risk of corrosion through use of a rubberized coating which prohibits detrimental contact (galvanic, oxidizing, or otherwise) between metals which have a tendency to react in a chemical manner.

It is another aspect to substantially reduce loss of valuable heating energy through thermal conductivity in a pipe or conduit.

It is an aspect of the present invention to provide an assembly and system that eliminates the necessity of installation coordination between piping journeymen and insulation install journeymen, while providing a superior overall installation.

It is an aspect of the present invention to provide for piping installers a device which firmly attaches pipe to structurally sound building components without relying on insulation to be an intermediary support between hardware and piping while simultaneously being readily adjustable to compensate for non-uniformity positioned mounting supports and absorptive of deforming energy (generated during either initial installation, earthquake, or other natural or manmade phenomenon.

The present invention relates to a pipe support construction that simplifies commercial installations of plumbing and steam fitting pipes and pipe assemblies. The present invention allows for comprehensive, one hundred percent, insulation coverage on any pipe without use of any accessories. The pipe to be installed is fastened directly to the pipe support through use of a circumferential clip formed into support and tightened with a screw. Intense friction is applied that prevents shifting of pipe along its length, thereby ensuring proper placement is maintained and there is no injury to the pipe. As discussed herein, the base of the support is stamped of flat steel with a bolt hole or opening provided, thereby allowing support to be mounted in any orientation, and with a multitude of hardware options. Most importantly, the energy absorbing unique bow shape and direct affixation to pipe allow for a cylindrical bat of fiberglass insulation to be installed over pipe without altering, cutting, or hollowing insulation in any way, thereby speeding installation of insulation and resolving coordination issues. The hanger also applies support directly to the pipe without transmitting weight through the insulation, thus providing for a more secure installation with fewer accessories.

According to an embodiment of the present invention, there is provided a pipe support construction for supporting a pipe relative to an external support brace, comprising a first support member spacing the pipe from the external support brace. The first support member further comprises a first and a second opposing parallel portion, spaced by an arcuate portion, thereby allowing a spring force to exist between the first and second opposing parallel portions during a use. Additionally, there are provided first connection means for removably connecting the first parallel portion of the first support member to the pipe and a second connection means for removably connecting the second opposing parallel portion of the first support member to the external support brace. The first connection means includes a non-reactive layer between an external surface of the pipe and a contact surface of the first connection means.

According to another embodiment of the present invention, there is provided a pipe support construction, further comprising a cylindraceous insulation member. The cylindraceous insulation member further comprises a central axial bounded region through a cross-section thereof and an access slit passing from an exterior of the cylindraceous member to an interior of the cylindraceous member.

According to another embodiment of the present invention, there is provided a pipe support construction, further comprising an outer surface flexible wrap member bounding regions of the cylindraceous insulation member following with the first support member. During the use following an installation of the cylindraceous insulation member, the outer surface flexible wrap member covers portions of the access slit, compressing opposing sides of the access slit into a close contact.

According to another embodiment of the present invention, there is provided a pipe clamping kit, comprising a first support member spacing a pipe from an external support brace. The first support member further comprises a first and a second opposing parallel portion spaced by an arcuate portion, thereby allowing a spring force to exist between the first and second opposing parallel portions during a use. Additionally, there are provided first connection means for removably connecting the first parallel portion of the first support member to the pipe, and second connection means for removably connecting the second opposing parallel portion of the first support member to the external support brace. There is also provided a cylindraceous insulation member comprising a central axial bounded region through a cross-section thereof and an access slit passing from an exterior of the cylindraceous member to an interior of the cylindraceous member, and an outer surface flexible wrap member bounding regions of the cylindraceous insulation member followed by the first support member. During the use following an installation of the cylindraceous insulation member, the outer surface flexible wrap member covers portions of the access slit, compressing opposing sides of the access slit into a close contact.

According to another embodiment of the present invention, there is provided a pipe clamping kit, wherein the first connection means further comprises a non-reactive layer between an external surface of the pipe and a contact surface of the first connection means.

According to another embodiment of the present invention, there is provided a pipe clamping kit, wherein the arcuate portion of the first support member traverses an arc of about 180 degrees from respective first and second opposing parallel members.

According to another embodiment of the present invention, there is provided a pipe hanging assembly, for supporting a pipe relative to an external support brace. The assembly comprises a first support bracket member extending from the external support brace. The bracket member has first and second opposing arcuate members therewithin which define opposing positions on reference portions of an outer surface of the pipe. The assembly additionally comprises a bounding member extending from the first support bracket member and surrounding the first and second opposing arcuate members and spaced therefrom. The spacing between the bounding member and the first and second opposing arcuate members define an insulation receiving location therein. The assembly also has opposing spacing members extending from outer portions of the first and second opposing arcuate members to inner surface positions of the bounding member, thus maintaining the insulation receiving location during a use, and preventing a compression of the insulation.

According to another embodiment of the present invention, there is provided a pipe support construction for supporting a pipe relative to an external support brace. The construction comprises a first support member spacing the pipe from the external support brace. The first support member further comprises first and a second opposing parallel portions spaced by a straight off-set portion, thereby allowing a spring force to exist between the first and second opposing parallel portions during a use whereby compressive forces may be exerted on the first and second opposing parallel portions causing their approach, which upon release, causes their departure and return to an original position. There is also provided first connection means for removably connecting the first parallel portion of the first support member to the pipe, and second connection means for removably connecting the second opposing parallel portion of the first support member to the external support brace. The first connection means includes a non-reactive layer between an external surface of the pipe and a contact surface of the first connection means.

According to another embodiment of the present invention, there is provided a pipe support construction for supporting a pipe relative to an external support brace, further comprising a cylindraceous insulation member which, in turn, comprises a central axial bounded region through a cross-section thereof, and an access slit passing from an exterior or the cylindraceous member to an interior of the cylindraceous member.

According to another embodiment of the present invention, there is provided a pipe support construction for supporting a pipe relative to an external support brace. This construction further comprises an outer surface flexible wrap member bounding regions of the cylindraceous insulation member and following with the first support member; whereby, during the use following an installation of the cylindraceous insulation member the outer surface flexible wrap member covers portions of the access slit compressing opposing sides of the access slit into a close contact.

According to another embodiment for the present invention, there is provided a pipe support kit, for supporting a pipe bound by an insulation member relative to an external support brace comprising a first support member flexibly spacing the pipe from the external support brace. The first support member further comprises a first and second opposing parallel portions spaced by a central spring portion, thereby allowing an elastic deformation spring force to be exerted between the first and second opposing parallel portions during a use without deformation thereof. Additionally, there is provided first connection means for removably connecting the first parallel portion of the first support member to the pipe, and second connection means for removably connecting the second opposing parallel portion of the first support member to the external support brace. The first connection means includes a non-reactive layer between an external surface of the pipe and a contact surface of the first connection means.

According to another embodiment of the present invention, there is provided a pipe support kit, wherein the insulation member is cylindraceous and further comprises a central axial bounded region through a cross-section thereof, and having at least one access slit passing from an exterior of the cylindraceous member to an interior of the cylindraceous member.

According to another embodiment of the present invention, there is provided a pipe support kit. The kit further comprises an outer surface flexible wrap member bounding regions of the cylindraceous insulation member following with the first support member, whereby during the use following an installation of the cylindraceous insulation member, the outer surface flexible wrap member covers portions of the access slit compressing opposing sides of the access slit into a close contact.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is an exploded perspective view of a conventional pipe hanging assembly showing the break in the insulation.

FIG. 1A is a side view of the assembly noted in FIG. 1.

FIG. 2 is an exploded perspective view of a different conventional pipe hanging assembly noting the break in the insulation.

FIG. 2A is a side view of the assembly noted in FIG. 2.

FIG. 3 is a front perspective view of a first embodiment of the present invention.

FIG. 3A is an exploded perspective view of the assembly shown in FIG. 3, depicting comprehensive insulation coverage.

FIG. 3B is an exploded perspective view of the embodiment in FIG. 3 in combination with a conventional channel support member.

FIG. 3C is a sectional view through line 3C-3C in FIG. 3, noting comprehensive insulation and wrapping with full pipe support.

FIG. 3D is a focused view from FIG. 3C noting direct contact between the assembly components.

FIG. 3E is an exploded close-up view of a portion of FIG. 3B noting the adaptable assembly components.

FIG. 3F is an exploded assembly view employing the first embodiment of the present invention in a hanging assembly adaptable to differing support positions.

FIG. 3G is a cross-sectional view of an alternative assembly of the present invention noting the use of an extending bolt member to enhance adaptability to differing support positions.

FIG. 3H is a perspective view noting an alternative assembly according to the present invention in combination with a wooden support member and increased pipe diameter.

FIG. 4A is a perspective view of an alternative embodiment of the present invention.

FIG. 4B is a sectional view through section 4B-4B in FIG. 4A with insulation assembled.

FIG. 5A is a perspective exploded view of another alternative embodiment of the present invention showing an alternative split-apart assembly.

FIG. 5B is a partial perspective assembly view of the fitting clamp noted in FIG. 5A.

FIG. 5C is a partial sectional view along section 5C-5C in FIG. 5A noting the continuous insulation coverage thereof.

FIG. 6A is an alternative embodiment of the present invention, wherein a supporting bracket engages a pipe with a flexible and adjustable plastic band.

FIG. 6B is a bottom view of the embodiment shown in FIG. 6A.

FIG. 6C is a top view of the embodiment shown in FIG. 6A.

FIG. 6D is a perspective top view of two alternative versions of the embodiment noted in FIG. 6A.

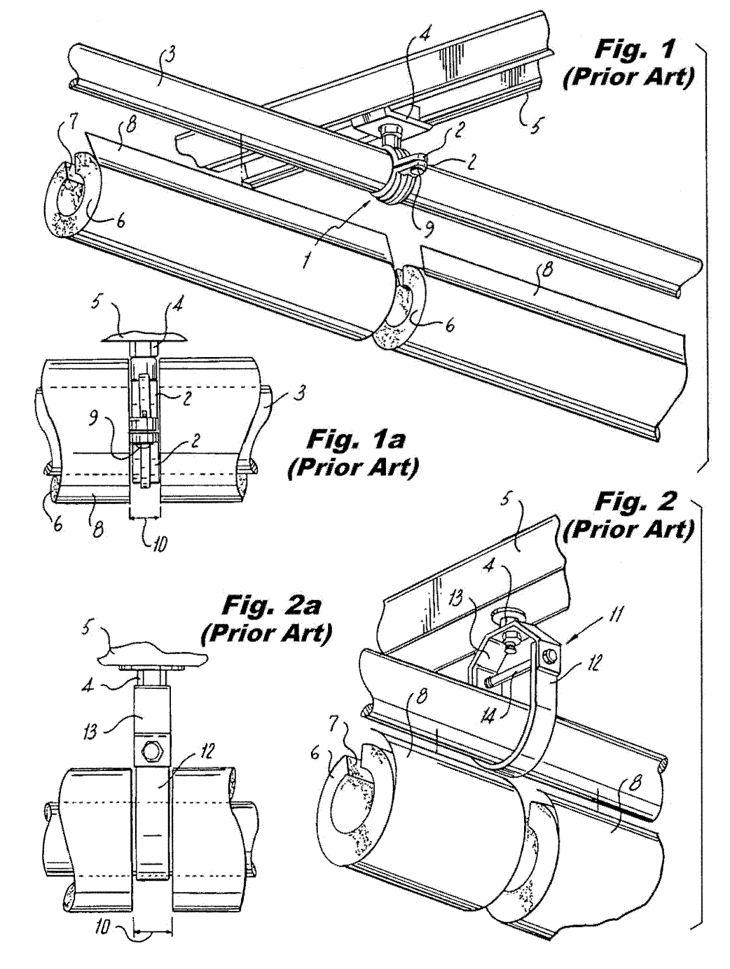

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These, and similar directional terms, should not be construed to limit the scope of the invention in any manner. The words “connect,” “couple,” and similar terms with their inflectional morphemes do not necessarily denote direct and immediate connections, but also include connections through mediate elements or devices.

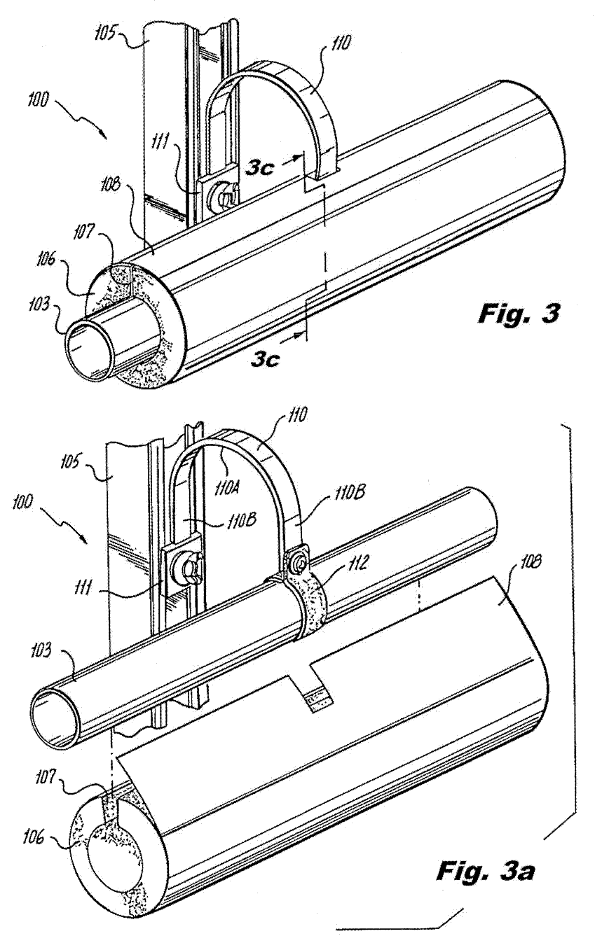

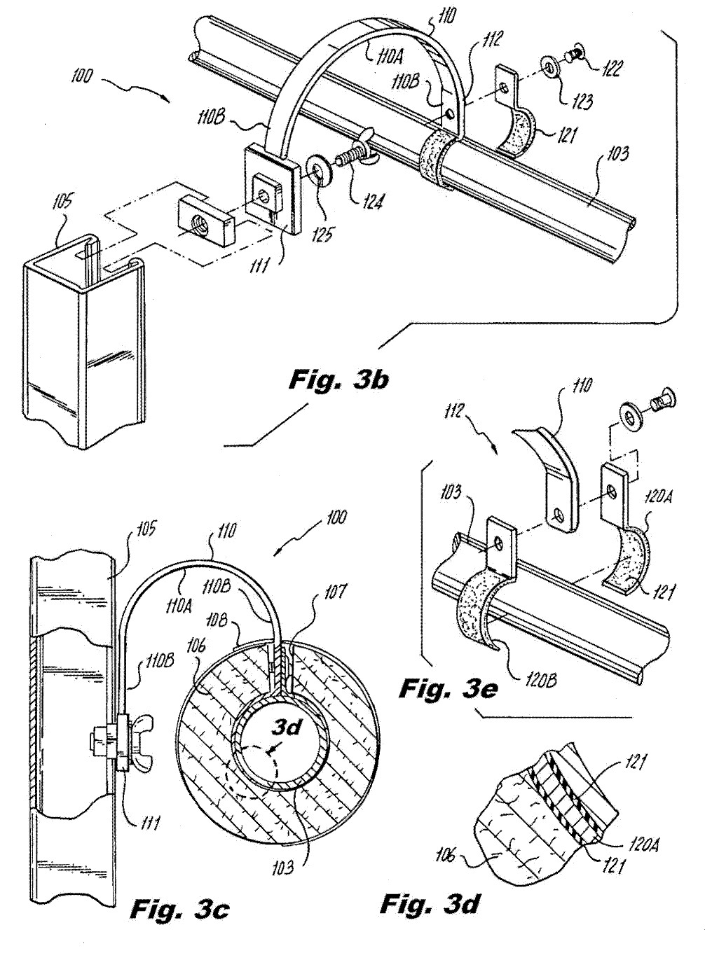

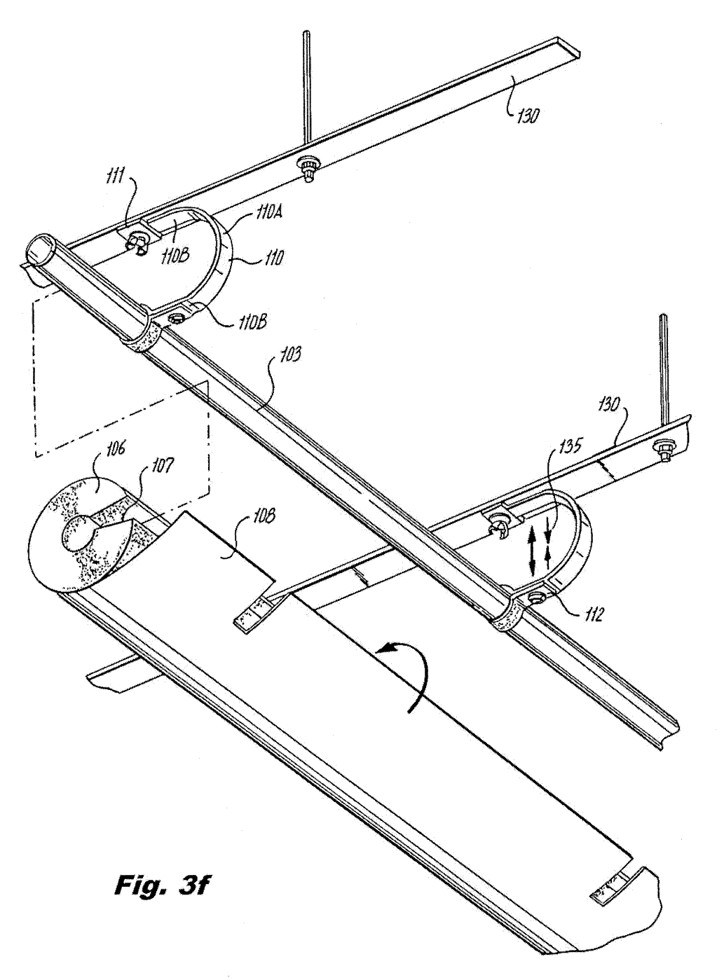

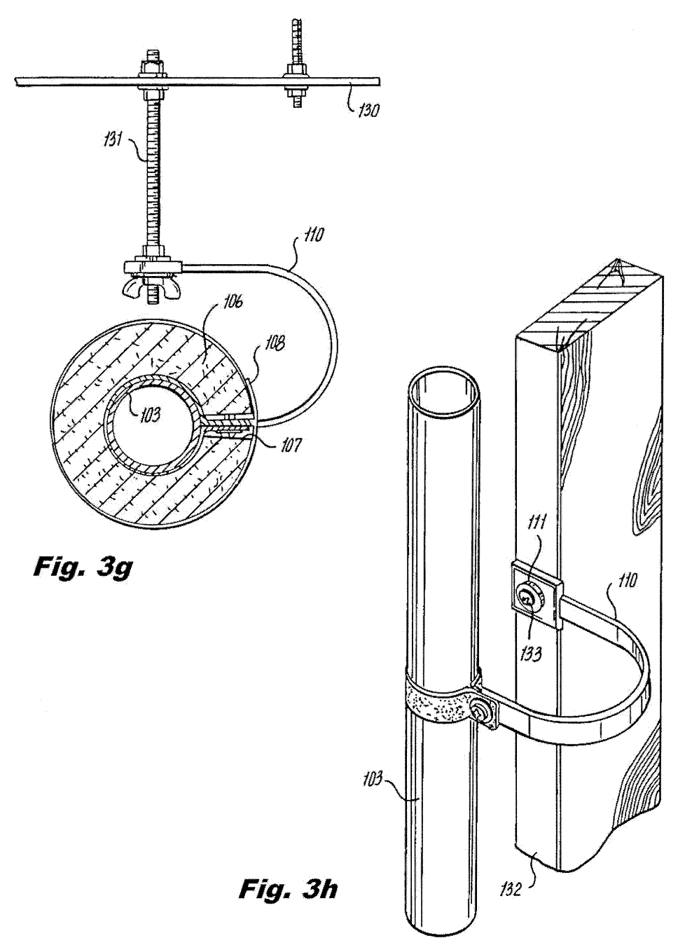

Referring now to FIGS. 3 through 3h, the present invention provides a pipe fitting assembly 100 for supporting a pipe member 103 and a surrounding insulation member 106 having a split insulation channel 107 and a surrounding flexible member 108 for wrapping the same.

As shown in FIGS. 3 through 3E a conventional channelized supporting bracket member 105 is employed as noted above.

The fitting assembly includes a spring-flexible and arcuate member 110 containing a central arcuate portion 110A spacing two linear sections 110B, 110B on either side thereof. On a first side of one linear section 110B, a fitting assembly 111 is positioned and is adapted to attachment in channel support member 105, as shown. On a second side of one linear section 110B, a second fitting assembly 112 is provided.

Second fitting assembly 112 comprises a first clamping member 120A and a second clamping member 120B having rubberized or non-reactive coatings 121. As will be noted particularly in FIGS. 3B-3D, second fitting assemblies include compressive threaded bolt members 122 and washers 123 so as to tightly join opposing clamping members 120A, 120B to second side linear section 110B, so as to tightly affix pipe member 103 to arcuate member 110. Similar bolt members 124 and washer members 125 allow the sliding adjustment of first linear section 111A relative to the respective support member 105, and ready removal and repositioning as may be required.

As will be noted in FIG. 3C, the instant assembly enables complete surrounding of pipe member 103 by insulation member 106 and wrapping with flexible outer covering 108 to prohibit thermal transfer and degradation of pipe and clamp assembly.

It will be appreciated by those of skill in the art, having studied the present disclosure, that arcuate member 110A is particularly useful to both compensation for the variety in support geometry, and, elimination of any gap within insulation slot 107 along the length of pipe 103. As will be appreciated, insulation 106 may be slightly compressed proximate bolt 123 and washer 125 to allow completely surrounding (100%) pipe member 103 to prohibit any thermal loss or condensation.

As an additional benefit, during initial installation by pipe fitters charged with maintaining the linearity of the pipe run through the relevant construction, the arcuate portion 110A may be inelastically manipulated to adjust the spacing between pipe 103 and support member 105 while maintaining the parallel orientation of first and second sides 110B, 110B so as to not damage pipe 103 or the respective fittings thereon.

As an additional benefit, it will be recognized by those of skill in the art, having studied the present disclosure, that arcuate member 110 functions as a supportive spring member so as to allow the ready absorption of vibration and movement/kinetic energy during either an earthquake or during content transfer, thereby minimizing stress on the pipe joints and minimizing damage thereto.

Referring now to FIG. 3F, an alternative assembly is noted, wherein non-aligned support members 130, 130 are shown in a mis-aligned arrangement due to installation defects. As noted therein, arcuate support member 110 is readily adjustable to each position of support member 130, 130 so that pipe member 103 can maintain a linear alignment between sections by varying a distance 135 between opposing parallel support faces. As a result, during installation the pipe fitting job is complete and readily adjustable, and the insulation job is also readily accomplished after installation without manipulating the installation clamps or risking damage to the pipe.

Referring now to FIG. 3G, it is noted that the present invention may be readily adjusted by a spacing bolt 131 assembly containing nuts and washers (shown but not numbered), wherein a threaded rod member (as bolt 131) may be employed for severe off-sets between support members 130 without departing from the scope and spirit of the present invention.

Referring now to FIG. 3H, another conventional support member 132 is shown here as a wooden post or beam and second fixing assembly 111 attached with a nail or screw 133 driven therethrough. As a consequence, the simplicity of initial installation, in either a horizontal or vertical position, is enabled relative to a ground surface in contrast to the conventional references, and fully enables the maintenance of a linear support to allow linear insulation channel 107 to close fully in a sealing manner during tight wrapping.

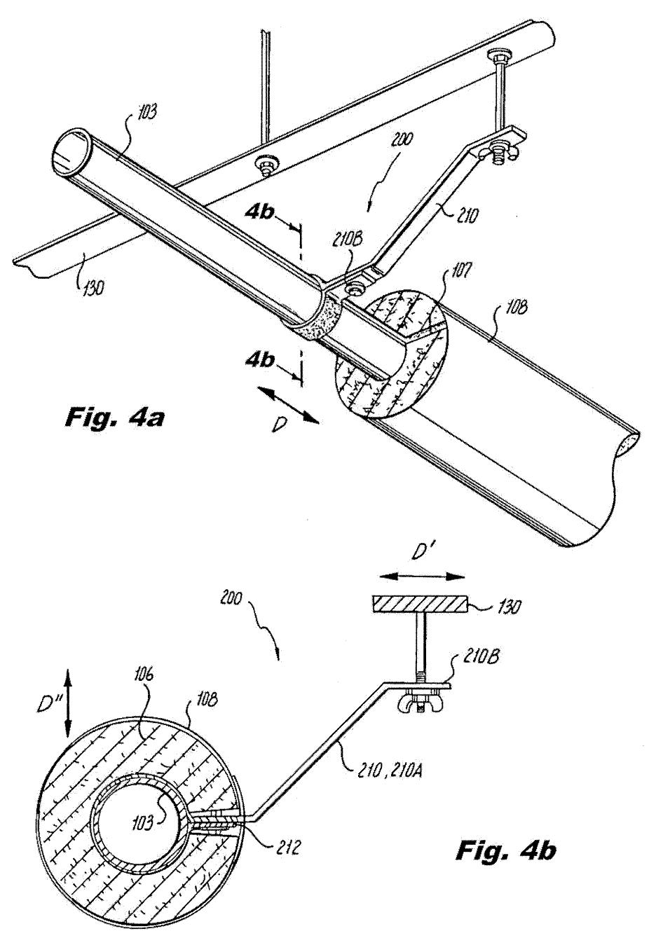

Referring now to FIGS. 4A and 4B, an alternative fitting assembly 200 is noted as attached to conventional support beam 130 with a non-arcuate flexible member 210, affixed as noted above to pipe member 103. As noted herein, assembly location 212 is maintained in parallel with an opposing parallel side on opposing parallel portions 210B, 210B of flexible member 210, with an angled portion 210A joined therebetween.

As will be noted, the present construction allows lateral flexing along direction D, D′, or D″ to compensate for construction defects, vibration from use or loading, and shifting during an earthquake or other vibratory phenomenon recognized by those of skill in the art.

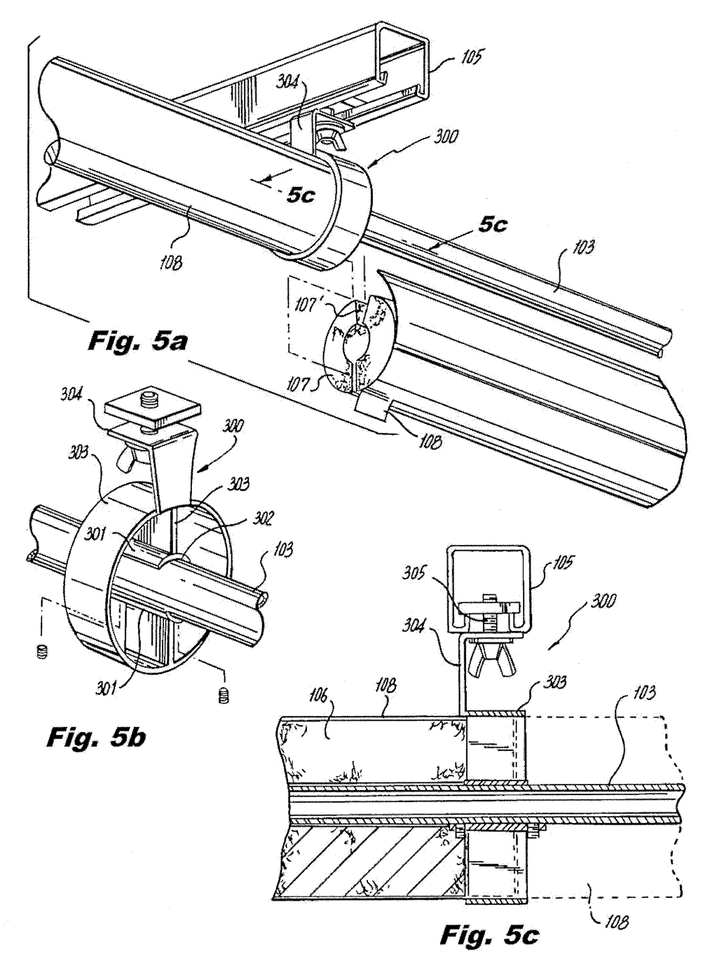

Referring now to FIGS. 5A-5C an alternative embodiment 300 is provided that provides support to both pipe 103 and insulation 106 in a manner that secures both and prohibits detrimental compression of insulation 106.

Suspension assembly 300 contains pipe clamping members 301, 301 as shown, each containing an arcuate section 302 and a bracing member 303 so as to clamp pipe 103 relative to assembly 300 during installation (optionally with a coating as noted earlier). A circumferential or outer surface supporting bounding member 303 additionally extends from a support bracket 304, as shown, to support both bounding member 303, and shaped to receive and support insulation 106, and pipe clamping members 301, 301. Threaded attachment members 305, noted earlier as a bolt, wing-nut, or threaded rod, and a washer or fixing bracket joint suspension assembly 300 are integrated with support member 105. As will be noted herein, insulation channel 107 is duplicated in a second insulation channel 107′ allowing both sides of support member 301, 301 to reach pipe 103. In an alternative assembly, support members 301, 301 may be merged into a single clamp, thereby eliminating secondary channel 107′. Similarly, the joining assembly 112 in FIG. 3B may be readily adopted into this embodiment within insulation support member 303 without departing from the scope and spirit of the present invention.

In the assembled view noted in FIG. 5C, it will be apparent to those of skill in the art having studied the same, that continuous insulation contact and connection is maintained without disassembly of the suspension assembly 300 following initial installation. In this manner, the present invention and embodiment greatly simplify both the pipe installation and insulation installation process without departing from the scope and spirit of the present discussions herein or the present invention.

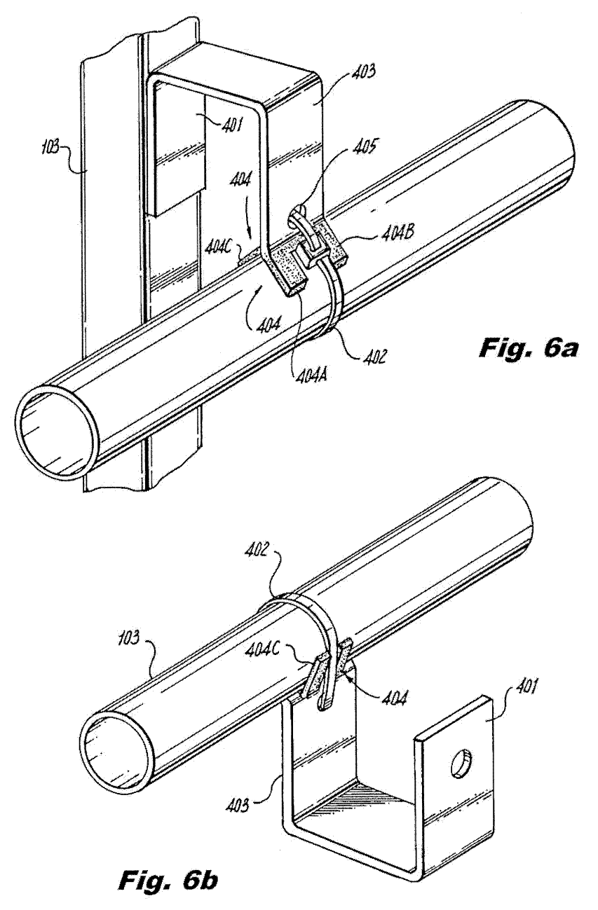

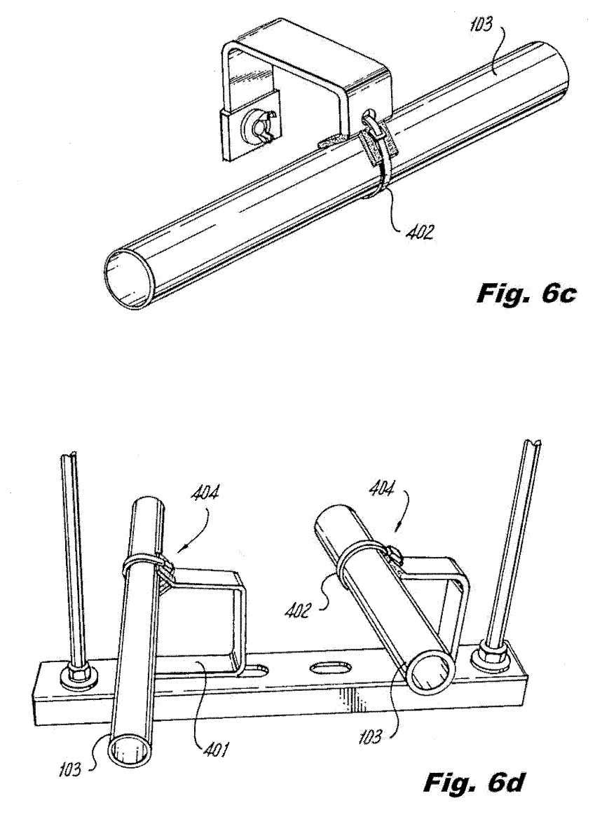

Referring now to FIGS. 6A through 6D, pipe 103 is alternatively supported by a formed bracket member 401 in combination with a flexible and adjustable locking member 402, conventionally operating as a zip-tie wherein a gated-end engages a ridged-end in a slip-through fashion flexibly adjustable to differing pipe shapes and pipe profiles.

Bracket member 401 includes a supporting haft 403 having a pipeengaging end containing three splayed finger members 404, respectively fingers 404A, 404B, and 404C. As noted in FIG. 6A, finger 404C is splayed approximately 90-120 degrees from fingers 404A, 404B, forming a receiving region to secure pipe 103 therewithin.

As will be apparent from the figures, an opening 405 is separately cut into supporting haft member 403 proximate the juncture between respective fingers and haft 403. It will be recognized by those of skill in the art, following thorough study of the present disclosure, that fingers 404 provide a splayed and rigid supporting seat, against which tension applied by locking member 402 retains pipe 103. During installation, pipe 103 is positioned between fingers 404 as shown; and, locking member 402 is initially engaged with supporting haft 403 and then tightened securing pipe 103 in place. Since haft 403 is very streamlined, as discussed above, it will not interfere with the installation and securing of a continuous insulating barrier. The present construction will also allow pipeinsulation actions to occur apart from pipe installation actions. Further, since the pipe is secured to the bracket, and since there is no requirement for un-securing the bracket to position insulation, a continuity of workflow is available.

In the claims, means, or step-plus-function clauses, are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. A pipe support construction, for supporting a pipe relative to an external support brace, comprising:
(a) a first support member spacing said pipe from said external support brace; said first support member further comprising a first and a second opposing parallel portion spaced by an arcuate portion, thereby allowing a spring force to exist between said first and said second opposing parallel portions during a use;
(b) first connection means for removably connecting said first parallel portion of said first support member to said pipe;
(c) second connection means for removably connecting said second opposing parallel portion of said first support member to said external support brace; and
(d) said first connection means including a non-reactive layer between an external surface of said pipe and a contact surface of said first connection means.

2. A pipe support construction, according to claim 1, wherein said first connection means further comprises:
(a) a spring-flexible and arcuate member containing a central arcuate portion for spacing one or more linear sections on either side thereof; and
(b) a fitting assembly located on a first side of said one or more linear section positioned and adapted to attachment in a channel support member.

3. A pipe support construction, according to claim 3, wherein said second connection means further comprises:
(a) a first clamping member and a second clamping member having rubberized or non-reactive coatings disposed thereon; and
(b) a compressive threaded bolt member and corresponding washer washers so as to tightly join first and said second clamping members to a second side linear portion, so as to tightly affix said pipe to said arcuate member.

4. A pipe support construction, according to claim 1, further comprising a cylindraceous insulation member; and, wherein said cylindraceous insulation member further comprises:
(a) a central axial bounded region through a cross-section thereof; and
(b) an access slit passing from an exterior or said cylindraceous member to an interior of said cylindraceous member.

5. A pipe support construction, according to claim 4, further comprising an outer surface flexible wrap member bounding regions of said cylindraceous insulation member and surrounding said first support member, whereby, during said use following an installation of said cylindraceous insulation member, said outer surface flexible wrap member covers portions of said access slit compressing opposing sides of said access slit into a close contact.

6. A pipe clamping kit, comprising:
(a) a first support member spacing a pipe from an external support brace, said first support member comprising a first opposing parallel portion and a second opposing parallel portion spaced by an arcuate portion, thereby allowing a spring force to exist between said first and said second opposing parallel portions during a use;
(b) first connection means for removably connecting said first parallel portion of said first support member to said pipe;
(c) second connection means for removably connection said second opposing parallel portion of said first support member to said external support brace;
(d) a cylindraceous insulation member, said cylindraceous insulation member further comprising:
(i) a central axial bounded region through a cross-section thereof; and
(ii) an access slit passing from an exterior of said cylindraceous member to an interior of said cylindraceous member; and
(e) an outer surface flexible wrap member bounding regions of said cylindraceous insulation member following with said first support member, whereby during said use following an installation of said cylindraceous insulation member said outer surface flexible wrap member covers portions of said access slit compressing opposing sides of said access slit into a close contact.

7. A pipe clamping kit, according to claim 6, wherein said first connection means further comprises a non-reactive layer between an external surface of said pipe and a contact surface of said first connection means.

8. A pipe clamping kit, according to claim 6, wherein said arcuate portion of said first support member traverses an arc of about 180 degrees from respective first and second opposing parallel members.

9. A pipe hanging assembly, for supporting a pipe relative to an external support brace, said pipe hanging assembly comprising:
(a) a first support bracket member extending from said external support brace;
(b) first and second opposing arcuate members in said first support bracket defining opposing positions on reference portions of an outer surface of said pipe;
(c) a bounding member extending from said first support bracket member and surrounding said first and said second opposing arcuate members and spaced therefrom, said spacing between said bounding member and said first and second opposing arcuate members defining an insulation receiving location therein; and
(d) opposing spacing members extending from outer portions of said first and second opposing arcuate members to inner surface positions of said bounding member, thereby maintaining said insulation receiving location therein during a use and preventing a compression of said insulation.

10. A pipe support construction, for supporting a pipe relative to an external support brace, said pipe support construction comprising:
(a) a first support member spacing said pipe from said external support brace, wherein said first support member comprises a first opposing parallel portion and a second opposing parallel portion spaced by a straight off-set portion, thereby allowing a spring force to exist between said first and second opposing parallel portions during a use, whereby compressive forces may be exerted on said first and said second opposing parallel portions causing their approach to one another, and, which upon release, causes their departure from each other and a return to an original position;
(b) first connection means for removably connecting said first parallel portion of said first support member to said pipe;
(c) second connection means for removably connection said second opposing parallel portion of said first support member to said external support brace; and
(d) said first connection means including a non-reactive layer between an external surface of said pipe and a contact surface of said first connection means.

11. A pipe support construction, according to claim 10, further comprising a cylindraceous insulation member, wherein said cylindraceous insulation member comprises a central axial bounded region through a cross-section thereof and an access slit passing from an exterior of said cylindraceous member to an interior of said cylindraceous member.

12. A pipe support system, according to claim 11, further comprising an outer surface flexible wrap member bounding regions of said cylindraceous insulation member and surrounding said first support member, and, whereby during said use following an installation of said cylindraceous insulation member, said outer surface flexible wrap member covers portions of said access slit compressing opposing sides of said access slit into a close contact.

13. A pipe support kit, for supporting a pipe bound by an insulation member relative to an external support brace, said pipe support kit comprising:
(a) a first support member flexibly spacing said pipe from said external support brace, and wherein said first support member comprises a first opposing parallel portion and a second opposing parallel portion spaced by a central spring portion, thereby allowing an elastic deformation spring force to be exerted between said first and said second opposing parallel portions during a use without deformation thereof;
(b) first connection means for removably connecting said first parallel portion of said first support member to said pipe;
(c) second connection means for removably connecting said second opposing parallel portion of said first support member to said external support brace; and
(d) said first connection means including a non-reactive layer between an external surface of said pipe and a contact surface of said first connection means.

14. A pipe support kit, according to claim 13, wherein said insulation member is cylindraceous and further comprises a central axial bounded region through a cross-section thereof and having at least one access slit passing from an exterior of said cylindraceous member to an interior of said cylindraceous member.

15. A pipe support kit, according to claim 14, further comprising an outer surface flexible wrap member bounding regions of said cylindraceous insulation member following with said first support member, and, whereby during said use following an installation of said cylindraceous insulation member, said outer surface flexible wrap member covers portions of said access slit compressing opposing sides of said access slit into a close contact.

16. A pipe support kit, according to claim 13, wherein said first connection means further comprises a non-reactive layer between an external surface of said pipe and a contact surface of said first connection means.

17. A pipe support kit, according to claim 13, wherein said arcuate portion of said first support member traverses an arc of about 180 degrees from respective first and second opposing parallel portions.

18. A pipe support kit, according to claim 13, wherein said first connection means further comprises:
(a) a spring-flexible and arcuate member containing a central arcuate portion for spacing one or more linear sections on either side thereof; and
(b) a fitting assembly located on a first side of said one or more linear section positioned and adapted to attachment in a channel support member.

19. A pipe support kit, according to claim 18, wherein said second connection means further comprises:
(a) a first clamping member and a second clamping member having rubberized or non-reactive coatings disposed thereon; and
(b) a compressive threaded bolt member and corresponding washer washers so as to tightly join first and said second clamping members to a second side linear portion, so as to tightly affix said pipe to said arcuate member.

20. A pipe support kit, according to claim 13, wherein said first support member further comprises a bracket member, said bracket member further comprising a supporting haft, and having a pipe-engaging end containing a first splayed finger member, a second splayed finger member, and a third splayed finger member, and wherein said second splayed finger member is splayed approximately 90-120 degrees from each of said first and said second splayed finger members and forming a receiving region to secure said pipe therewithin.
